(19) United States
(12) Patent Application Publication
(10) Pub. No.: US 2011/0176734 A1
(43) Pub. Date: Jul. 21, 2011

(54) APPARATUS AND METHOD FOR RECOGNIZING BUILDING AREA IN PORTABLE TERMINAL

(75) Inventors: Sang-Hwa Lee, Seoul (KR); Seong-Jong Ha, Namyangju-si (KR); Hyun-Su Hong, Seongnam-si (KR); Nam-Ik Cho, Seoul (KR); Gye-Joong Shin, Seongnam-si (KR); Sang-Uk Lee, Seoul (KR)

(73) Assignees: SAMSUNG ELECTRONICS CO., LTD., Suwon-si (KR); SNU R&DB FOUNDATION, Seoul (KR)

(21) Appl. No.: 13/011,572

(22) Filed: Jan. 21, 2011

(30) Foreign Application Priority Data
Jan. 21, 2010 (KR) 10-2010-0005661

(51) Int. Cl. G06K 9/48; G06K 9/46

(52) U.S. Cl. 382/197; 382/201

(57) ABSTRACT

An apparatus and method for recognizing a specific area of an image in a portable terminal. More particularly, an apparatus and method are for determining feature points with very high similarities as one group when the portable terminal recognizes a building included in an image or a picture, and for estimating a matching relation of the group to improve building recognition performance. The apparatus includes an image analyzer configured to, upon extracting feature points used for building recognition, classify feature points with similarities among the extracted feature points into a group, and recognize a building after estimating a matching relation by regarding the classified group as a feature point.

### CROSS-REFERENCE TO RELATED APPLICATION(S) AND CLAIM OF PRIORITY

The present application is related to and claims the benefit under 35 U.S.C. §119(a) to an application filed in the Korean Intellectual Property Office on Jan. 21, 2010 and assigned Serial No. 10-2010-0005661, the entire disclosure of which is hereby incorporated by reference.

### TECHNICAL FIELD OF THE INVENTION

The present invention relates to an apparatus and method for recognizing a specific area of an image in a portable terminal. More particularly, the present invention relates to an apparatus and method for determining feature points with very high similarities as one group when the portable terminal recognizes a building included in an image or a picture, and for estimating a matching relation of the group to improve building recognition performance.

### BACKGROUND OF THE INVENTION

Recently, with the rapid development of mobile technologies, portable terminals providing wireless voice calls and data exchanges are regarded as personal necessity of life. Conventional portable terminals have generally been regarded as portable devices providing wireless calls. However, along with technical advances and introduction of the wireless Internet, the portable terminals are now used for many purposes in addition to simple telephone calls or scheduling. For example, the portable terminals provide a variety of functions to satisfy users' demands, such as, games, remote controlling using near field communication, capturing images using a built-in digital camera, scheduling, and so forth.

The digital camera function enables capturing of a moving subject as well as a still image and thus is one of the functions that are the most frequently used by a user.

Recently, there is a method of searching for an area which is identical to a specific area included in image data obtained by using the digital camera from other image data.

For example, when the portable terminal intends to search for information on a building included in the captured image, the portable terminal may recognize the building included in the image and then may obtain information on the building by searching pre-stored data.

In general, the portable terminal may recognize the building by using a feature point and color of the building or may recognize the building by analyzing a vanishing point at infinity.

The method of searching for the specific area from other image data may generate an error according to conditions of various buildings. For example, in an environment where an outer wall of the building is made of glass or there is a significant change in a surrounding illumination condition, the color of the outer wall of the building is significantly changed. Therefore, an error may occur when the building is recognized by using color information. In addition, since the portable terminal repetitively extracts feature points with very high similarities with respect to an outer wall made of glass or an outer wall having a repetitive pattern such as a wall constructed with identical bricks, it becomes difficult or impossible to estimate a matching relation of the feature points, which may lead to an error in building recognition.

As a result, even if the portable terminal extracts the plurality of feature points, the matching relation of the feature points with very high similarities cannot be estimated, which results in a failure in building recognition.

Accordingly, there is a need for an apparatus and method for improving building recognition performance by solving the aforementioned problem in the portable terminal.

### SUMMARY OF THE INVENTION

To address the above-discussed deficiencies of the prior art, one aspect of the present invention is to solve at least the above-mentioned problems and/or disadvantages and to provide at least the advantages described below. Accordingly, an aspect of the present invention is to provide an apparatus and method for improving a recognition rate of a building area having feature points with very high similarities in a portable terminal.

Another aspect of the present invention is to provide an apparatus and method for avoiding a failure of estimation on a matching relation of feature points when there are many feature points with very high similarities in a building recognition process in a portable terminal.

Another aspect of the present invention is to provide an apparatus and method for improving a recognition rate of a building area by regarding feature points with very high similarities among feature points showing the same characteristic as one feature point in a portable terminal.

Another aspect of the present invention is to provide an apparatus and method for recognizing a building area by estimating a matching relation of a group consisting of feature points with very high similarities in a portable terminal.

In accordance with an aspect of the present invention, an apparatus for recognizing a building area in a portable terminal is provided. The apparatus includes an image analyzer configured to, upon extracting feature points to be used for building recognition, classify feature points with similarities among the extracted feature points into a group, and recognize a building after estimating a matching relation by regarding the classified group as a feature point.

In accordance with another aspect of the present invention, a method for recognizing a building area in a portable terminal is provided. The method includes, upon extracting feature points to be used for building recognition, classifying feature points with similarities among the extracted feature points into a group, and recognizing a building after estimating a matching relation by regarding the classified group as a feature point.

In accordance with another aspect of the present invention, an apparatus for recognizing a building area in a portable terminal is provided. The apparatus includes a feature point extractor configured to extract feature points necessary for building recognition. The apparatus also includes a grouping unit configured to classify feature points with similarities among the extracted feature points and group the classified feature points. The apparatus further includes a recognition unit configured to recognize a building after estimating a matching relation by using the grouped feature points.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a structure of a portable terminal for recognizing a building area by using a feature group consisting of feature points with very high similarities according to an embodiment of the present invention;

FIG. 2 illustrates a process of recognizing a partial area of an image in a portable terminal according to an embodiment of the present invention;

FIG. 3 illustrates a process of grouping feature points with very high similarities in a portable terminal according to an embodiment of the present invention;

FIG. 4 illustrates a process of comparing feature points of an input image and a comparative image in a portable terminal according to an embodiment of the present invention; and

FIG. 5 illustrates a pose estimation process and a partial area recognition process which are performed using a matching relation in a portable terminal according to an embodiment of the present invention.

### DETAILED DESCRIPTION OF THE INVENTION

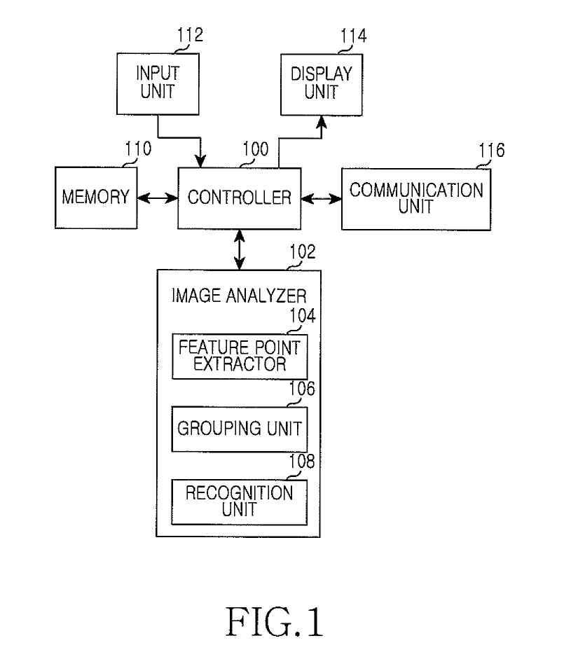

FIGS. 1 through 5, discussed below, and the various embodiments used to describe the principles of the present disclosure in this patent document are by way of illustration only and should not be construed in any way to limit the scope of the disclosure.

The present invention described hereinafter relates to an apparatus and method for improving a recognition rate of a building area by regarding a feature group, which is a collection of feature points with very high similarities among feature points showing the same characteristic, as one feature point in a portable terminal. Hereinafter, an input image is defined as an image selected by a user, for example, an image captured by the portable terminal or a pre-stored image, and a comparative image is defined as a plurality of images which are implemented into a database and used as a reference for determining a building or a feature vector of buildings.

FIG. 1 illustrates a structure of a portable terminal for recognizing a building area by using a feature group consisting of feature points with very high similarities according to an embodiment of the present invention.

As shown FIG. 1, the portable terminal may include a controller 100, an image analyzer 102, a memory 110, an input unit 112, a display unit 114, and a communication unit 116. The image analyzer 102 may include a feature point extractor 104, a grouping unit 106, and a recognition unit 108. The portable terminal may include additional units. Similarly, the functionality of two or more of the above units may be integrated into a single component.

The controller 100 of the portable terminal provides overall control to the portable terminal. For example, the controller 100 processes and controls voice telephony and data communications. In addition to its typical function, according to the present invention, the controller 100 performs an operation for improving a recognition rate of a building included in an image.

Since feature points with very high similarities are repetitively extracted in building recognition according to a characteristic in which the building has a repetitive outer wall structure, a matching relation of the feature points cannot be estimated. To avoid this problem, the controller 100 estimates the matching relation by grouping the feature points with very high similarities and then by regarding the grouped feature points as one feature point, thereby improving a building recognition rate.

The image analyzer 102 extracts feature points for recognizing the building under the control of the controller 100, and classifies the feature points with very high similarities as one group among the extracted feature points.

Thereafter, the image analyzer 102 regards the classified group as one feature point, and thereafter recognizes the building by estimating the matching relation of the feature points.

The feature point extractor 104 of the image analyzer 102 extracts the feature points necessary for building recognition by using a Scale Invariant Feature Transform (SIFT), a Speeded Up Robust Feature (SURF), and the like, and expresses a texture property of a building surface into a specific descriptor vector. The feature point extractor 104 extracts a plurality of feature points with very high similarities according to a characteristic of a building having a repetitive outer wall structure.

The grouping unit 106 of the image analyzer 102 determines the feature points extracted by the feature point extractor 104 by grouping them, and classifies the feature points with very high similarities as one group.

The grouping unit 106 selects any one of the plurality of feature points as a reference point, compares the selected reference point with other feature points, and determines that the feature points have very high similarities when a distance between the feature points is short. The grouping unit 106 classifies the feature points determined as the feature points with the high similarity as one group. When a new neighboring feature point is added to a group while performing a process of classifying all feature points into the group, the grouping unit 106 expresses a representative vector by using an average of feature vectors included in the group and selects the representative vector as a new reference point.

The feature point added to the group has a high similarity with respect to the reference point, and may be restricted to have a high correlation with a spatial position of the grouped feature points. That is, the grouping unit 106 may analyze a location relation of the feature points by considering a regular characteristic of a building structure and may estimate regularity so that feature points conforming to the regularity are grouped.

The recognition unit 108 of the image analyzer 102 estimates the matching relation by regarding the group classified by the grouping unit 106 as the feature point and then recognizes the building.

The recognition unit 108 may estimate the matching relation by searching for a representative vector which denotes an average vector of the grouped feature vectors, and thereafter may give a weight to the matching relation and thus may use a grouped feature point or an ungrouped feature point as a parameter to be used in building recognition.

After estimating the matching relation, the recognition unit 108 may recognize the building included in the image by using a result of the matching relation. However, the recognition unit 108 may combine the number of matched feature points and a homography transformation result to improve building recognition performance. Therefore, an error of not recognizing a building included in an area not conforming to a homography result is avoided even if the number of matched feature points is great.

The memory 110 includes a Read Only Memory (ROM), a Random Access Memory (RAM), a flash ROM, and such. The ROM stores a microcode of a program, by which the controller 100 and the image analyzer 102 are processed and controlled, and a variety of reference data.

The RAM is a working memory of the controller 100 and stores temporary data that is generated while programs are performed. In addition, the flash ROM stores a variety of refreshable data, such as phonebook entries, outgoing messages, and incoming messages.

The input unit 112 includes a plurality of function keys such as numeral key buttons of ‘0’ to ‘9’, a menu button, a cancel button, an OK button, a talk button, an end button, an Internet access button, a navigation key button, a character input key, and such. Key input data, which is input when the user presses these keys, is provided to the controller 100.

The display unit 114 displays information such as state information, which is generated while the portable terminal operates, moving and still pictures, and the like. The display unit 112 may be a color Liquid Crystal Display (LCD), an Active Mode Organic Light Emitting Diode (AMOLED), or any other suitable display. When the display unit 114 is equipped with a touch input device and thus is applied to a touch input-type portable terminal, the display unit 114 may be used as an input device.

The communication unit 116 transmits and receives a Radio Frequency (RF) signal of data that is input and output through an antenna (not illustrated). For example, in a transmitting process, data to be transmitted is subject to a channel-coding process and a spreading process, and then the data is transformed to an RF signal. In a receiving process, the RF signal is received and transformed to a base-band signal, and the base-band signal is subject to a de-spreading process and a channel-decoding process, thereby restoring the data.

Although a function of the image analyzer 102 can be performed by the controller 100 of the portable terminal, the image analyzer 102 and the controller 100 are separately constructed in the present invention for exemplary purposes only. Thus, those ordinary skilled in the art can understand that various modifications can be made within the scope of the present invention. For example, functions of the image analyzer 102 and the controller 100 can be integrally configured to be processed by the controller 100.

An apparatus for improving a recognition rate of a building area by regarding a feature group, which is a collection of feature points with very high similarities, as one feature point in a portable terminal has been described above. Hereinafter, a method of improving the recognition rate of the building area by estimating a matching relation in such a manner that the feature group is regarded as one feature point by using the apparatus of the present invention will be described.

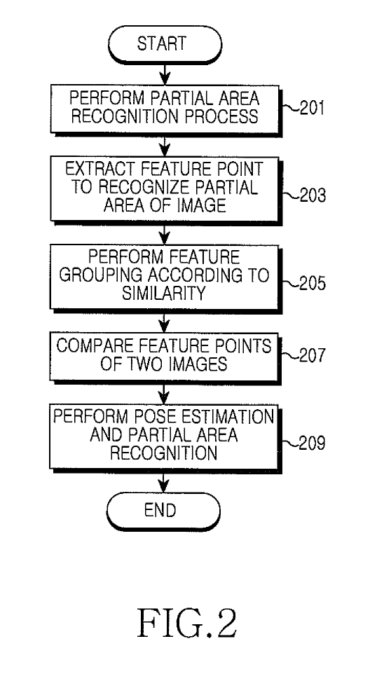

FIG. 2 illustrates a process of recognizing a partial area of an image in a portable terminal according to an embodiment of the present invention.

As shown in FIG. 2, the partial area is a specific area included in the image. A building area will be described as an example of the partial area in the present invention.

To recognize the partial area, in step 201, the portable terminal performs a partial area recognition process for recognizing a building included in the image by using a texture-based feature extraction technique according to the present invention.

After performing the partial area recognition process, proceeding to step 203, the portable terminal extracts a feature point for recognizing the partial area of the image. Herein, the feature point is a reference point for recognizing the building from an input image, and may be a window, a signboard, a painting on an outer wall, and the like. The portable terminal may extract the feature point by using a feature extraction technique such as SIFT, SURF, or any other suitable technique.

A typical portable terminal estimates a matching relation between the feature point extracted from the input image and a feature point extracted from a comparative image, and thereafter recognizes an area identical to the partial area of the input image from the comparative image.

However, in the aforementioned method, building recognition is not performed when the extracted feature point is not matched when the feature point is extracted regularly due to a repetitive outer wall structure of the building. That is, if the building is recognized in the conventional portable terminal, then the building can be recognized only when the outer wall of the building included in the image is not a glass wall, and also when color and external views of the building are unique.

Accordingly, after extracting the feature point in step 203, proceeding to step 205, the portable terminal performs a feature grouping process for grouping feature points according to similarities of the extracted feature points.

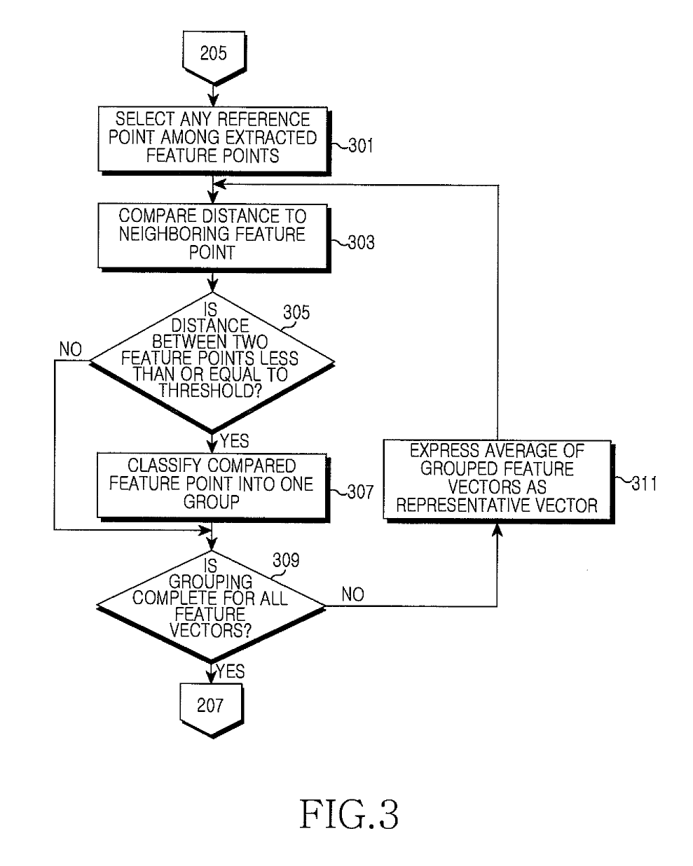

Herein, as described above, the feature grouping process is a process in which among feature points extracted regularly from the building having the repetitive structure, feature points with very high similarities are grouped to be regarded as one feature point. The feature grouping process will be described below in detail with reference to FIG. 3.

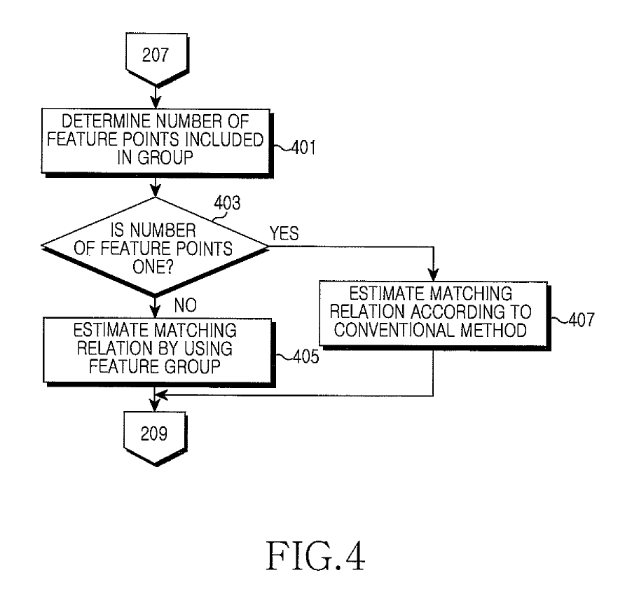

In step 207, the portable terminal compares the feature points of the input image and the comparative image and estimates the matching relation of the feature points. The estimation of the matching relation of the feature points is used to determine an area of the comparative image including the building of the input image, and will be described below in detail with reference to FIG. 4.

In step 209, the portable terminal performs a pose estimation process and a partial area recognition process by using the matching relation estimated in step 207.

In general, the greater the number of matching cases between the feature point extracted from the input image and the feature point extracted from the comparative image, the higher the possibility that the portable terminal recognizes that buildings included in the two images are identical. However, since the building included in the input image can rotate depending on an angle at which a user captures the image, building recognition cannot be correctly performed by using the matching relation of the feature points.

Accordingly, the portable terminal may improve building recognition performance in such a manner that a pose change matrix between the images is estimated by using the matched feature points, and the buildings of the input image and the comparative image are determined to be identical when the estimation result satisfies a pose change result.

In addition, the portable terminal may improve the building recognition performance by combining the number of the matched feature points and a homography transformation result.

That is, the portable terminal prevents an error of not recognizing a building with respect to an area not conforming to the homography result even if the number of matched feature points is great.

The portable terminal for performing the aforementioned operation may functionalize an error caused by homography transformation and the number of matched feature points together. Thus, a function may be pre-defined such that the less the error caused by the homography transformation and the greater the number of matched feature points, the higher the possibility of recognizing that buildings included in the input image and the comparative image are identical. A parameter of the function may be regulated to change priority by giving a higher weight on the number of matched feature points or a homography transformation error.

Thereafter, the procedure of FIG. 2 ends.

FIG. 3 illustrates a process of grouping feature points with very high similarities in a portable terminal according to an embodiment of the present invention.

As shown in FIG. 3, the portable terminal selects any reference point among extracted feature points in step 301.

In step 303, the portable terminal compares a distance between the reference point selected in step 301 and a neighboring feature point existing in a neighboring area. In step 305, the portable terminal determines whether a distance between the two feature points (i.e., the reference point and the neighboring feature point) is less than or equal to a threshold.

Herein, the portable terminal determines that feature points have very high similarities when the distance between the feature points is small, and determines that feature points have different characteristics when the distance between the feature points is great. The portable terminal may determine the feature points with high similarities by using [Eqn. 1] below.

∥P₁−P₂∥<T1 [Eqn. 1]

In [Eqn. 1], P₁ denotes any reference point among extracted feature points, P₂ denotes another feature point existing in a neighboring area, and T1 denotes a threshold for determining similarities between feature points.

If it is determined in step 305 that the distance between the two feature points is less than or equal to the threshold and thus the neighboring feature point is determined as a feature point having a very high similarity with respect to the reference point, then proceeding to step 307, the portable terminal allows the neighboring feature point with the very high similarity to be included in the one group.

If the neighboring feature point is included in one group or if it is determined in step 305 that the distance between the two feature points is greater than or equal to the threshold and thus it is determined that the neighboring feature point is not similar to the reference point, then proceeding to step 309, the portable terminal determines whether the grouping process is complete for all feature vectors, i.e., all neighboring feature points.

If it is determined in step 309 that the grouping process is not complete for all neighboring feature points, then proceeding to step 311, the portable terminal expresses an average of the grouped feature vectors as a representative vector and selects the representative vector as a new reference point.

In this situation, the portable terminal may obtain an average vector of the grouped feature vectors by using [Eqn. 2] below.

$${P}_{mean} = \frac{1}{N ( G )} {\sum }_{i = G} {P}_{i} \qquad [ Eqn . 2 ]$$

In [Eqn. 2], Pₘₑₐₙ denotes an average vector of grouped feature vectors, and N(G) denotes the number of feature points included in a group.

After selecting the new reference point, the process of step 303 is repeated.

If it is determined in step 309 that the grouping process is complete for all neighboring feature points, returning to step 207 of FIG. 2, the portable terminal performs the process of comparing the feature points of the input image and the comparative image.

FIG. 4 illustrates a process of comparing feature points of an input image and a comparative image in a portable terminal according to an embodiment of the present invention.

As shown in FIG. 4, the portable terminal determines the number of feature points included in a group consisting of feature points with very high similarities in step 401.

In step 403, the portable terminal determines whether the number of feature points included in the group is one.

If it is determined in step 403 that one feature point is included in the group, then proceeding to step 407, the portable terminal performs the conventional method of estimating a matching relation by using one feature point.

Otherwise, if it is determined in step 403 that a plurality of feature points are included in the group, then proceeding to step 405, the portable terminal estimates the matching relation by using a feature group.

In this situation, the portable terminal estimates the matching relation by searching for a representative vector which denotes an average vector of the grouped feature vectors. The portable terminal may estimate the matching relation by using [Eqn. 3] below on the basis of a Euclidean distance.

∥Pₘₑₐₙ₁−Pₘₑₐₙ₂∥<T1 [Eqn. 3]

In [Eqn. 3], Pₘₑₐₙ denotes a representative vector, and ∥Pₘₑₐₙ₁−Pₘₑₐₙ₂∥ denotes a distance between representative vectors. In addition, T1 denotes a threshold for determining a matching relation between the representative vectors.

After estimating the matching relation by using the feature group, returning to step 209 of FIG. 2, the portable terminal performs the pose estimation process and the partial area recognition process by using the matching relation.

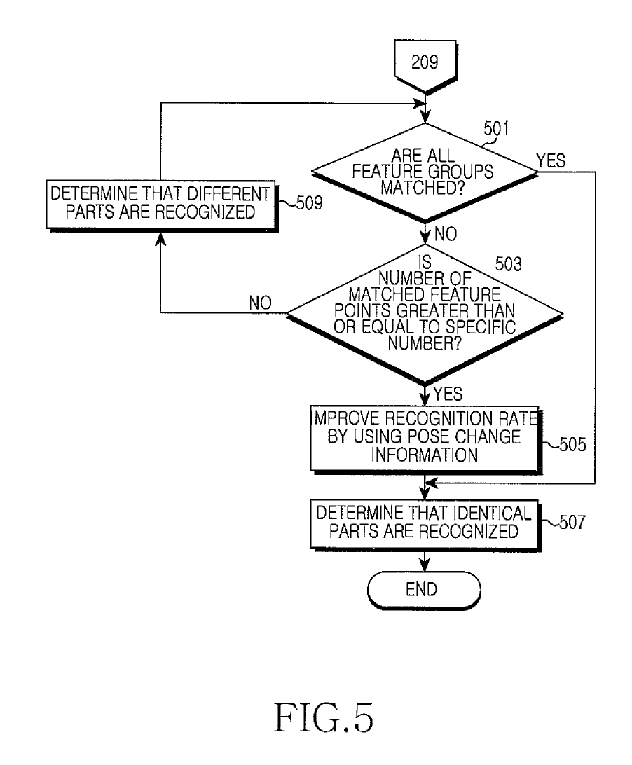

FIG. 5 illustrates a pose estimation process and a partial area recognition process which are performed using a matching relation in a portable terminal according to an embodiment of the present invention.

As shown in FIG. 5, in step 501, the portable terminal performs a process of analyzing the matching relation estimated in step 405 of FIG. 4. Herein, the portable terminal determines whether all feature groups are matched. That is, the portable terminal determines whether a representative vector which denotes an average vector of grouped feature vectors is matched.

If it is determined in step 501 that all feature groups are matched, then proceeding to step 507, the portable terminal determines that a building area included in an input image is recognized from a comparative image.

Otherwise, if it is determined in step 501 that all feature groups are not matched, then proceeding to step 503, the portable terminal determines whether there are more than a specific number of matched feature points. The process of step 503 is for analyzing a matching relation of feature points included in a feature group.

If it is determined in step 503 that less than the specific number of feature points are matched, then proceeding to step 509, the portable terminal determines that it fails to recognize the building area included in the input image from the comparative image.

If it is determined in step 503 that less than the specific number of feature points are matched, the portable terminal determines that the building area is recognized by using [Eqn. 4] below.

$$α {\sum }_{G} N ( G ) + ( 1 - α ) N ( {P}_{s} ) < T 2 \qquad [ Eqn . 4 ]$$

In [Eqn. 4], N(G) denotes the number of feature points of an input image or comparative image group, while the number of feature points of a pre-stored (sampled) comparative image group is also denoted by N(G) to be used as a reference for building area recognition. N(Pₛ) denotes the total number of matching cases of an ungrouped single feature vector, and α denotes a weight for a feature point used for building recognition, where α may be greater than or equal to 0 and less than 1. T2 denotes a reference value for determining whether recoguition is achieved.

Referring to [Eqn. 4] above, the portable terminal may change an importance of a feature point used for building recognition by using the weight α.

For example, if the portable terminal recognizes a building area by using an ungrouped feature point (herein, α is set to “0”), whether building recognition is achieved will be determined by comparing magnitudes of N(Pₛ) and T2.

In contrast, if the portable terminal recognizes the building area by using a grouped feature point (herein, α is set to “1”), whether building recognition is achieved will be determined by comparing magnitudes of N(G) and T2.

That is, the portable terminal increases a building recognition rate by using grouped feature points when several representative vectors are matched.

After recognizing the building area, proceeding to step 505, the portable terminal performs a process of improving the building area recognition rate by using pose change information.

The portable terminal may combine the number of matched feature points and a homography transformation result to improve building recognition performance. Therefore, an error of not recognizing a building included in an area not conforming to a homography result is avoided even if the number of matched feature points is great.

The portable terminal for performing the aforementioned operation may functionalize an error caused by homography transformation and the number of matched feature points together. Thus, a function may be pre-defined such that the less the error caused by the homography transformation and the greater the number of matched feature points, the higher the possibility of recognizing that buildings included in the input image and the comparative image are identical. A parameter of the function may be regulated to change priority by giving a higher weight on the number of matched feature points or a homography transformation error.

In step 507, the portable terminal determines that the building area included in the input image is recognized from the comparative image.

In addition, after analyzing a location relation of feature points extracted regularly, the portable terminal may recognize that the buildings included in the input image and the comparative image are identical by comparing regularity of feature points between the images. For example, since feature points are distributed at a location having a specific regularity in a regular structure such as a window frame of a building, when feature points are extracted, the portable terminal analyzes a location relation of the extracted feature points, estimates a regular arrangement pattern of the feature points, and compares the estimation results to be applied to building recognition. That is, the portable terminal derives a linear equation from locations of the extracted feature points, estimates a relative distance relation, and compares the measurement results by using various projection transform, and in this manner, can determine whether the buildings included in the two images are identical.

Thereafter, the procedure of FIG. 5 ends.

According to embodiments of the present invention, a portable terminal regards a feature group, which is a collection of feature points with very high similarities among feature points showing the same characteristic, as one feature point, and estimates a matching relation for the feature group. Therefore, it is possible to avoid a failure of building area recognition when a matching relation of the feature points with very high similarities is not successfully estimated in the conventional portable terminal.

While the present invention has been shown and described with reference to certain exemplary embodiments thereof, it will be understood by those skilled in the art that various changes in form and details may be made therein without departing from the spirit and scope of the present invention as defined by the appended claims and their equivalents. Therefore, the scope of the invention is defined not by the detailed description of the invention but by the appended claims and their equivalents, and all differences within the scope will be construed as being included in the present invention.

What is claimed is:

1. An apparatus for recognizing a building area in a portable terminal, the apparatus comprising an image analyzer configured to, upon extracting feature points to be used for building recognition, classify feature points with similarities among the extracted feature points into a group, and recognize a building after estimating a matching relation by regarding the classified group as a feature point.

2. The apparatus of claim 1, wherein the image analyzer is configured to select any feature point among the extracted feature points as a reference point and compare a distance between the reference point and a neighboring feature point, and if the compared distance is less than or equal to a threshold, determine that the compared feature point belongs to the feature points with similarities and classify the feature points with similarities into the group.

3. The apparatus of claim 2, wherein the image analyzer is configured to classify the feature points with similarities into the group by using the following equation:
∥P₁−P₂∥<T1,
where P₁ denotes any reference point among extracted feature points, P₂ denotes another feature point existing in a neighboring area, and T1 denotes a threshold for determining similarities between feature points.

4. The apparatus of claim 2, wherein after classifying the feature points with similarities into the group, the image analyzer compares a distance to the neighboring feature point by determining an average of feature vectors of the group as a new reference point.

5. The apparatus of claim 4, wherein the image analyzer is configured to determine the average of feature vectors by using the following equation:
$${P}_{mean} = \frac{1}{N ( G )} {\sum }_{i = G} {P}_{i} ,$$
where Pₘₑₐₙ denotes an average vector of grouped feature vectors, and N(G) denotes the number of feature points included in the group.

6. The apparatus of claim 1, wherein the image analyzer is configured to estimate the matching relation by searching for a representative vector by using the following equation:
∥Pₘₑₐₙ₁−Pₘₑₐₙ₂∥<T1,
where Pₘₑₐₙ denotes a representative vector, ∥Pₘₑₐₙ₁−Pₘₑₐₙ₂∥ denotes a distance between representative vectors, and T1 denotes a threshold for determining the matching relation between the representative vectors.

7. The apparatus of claim 6, wherein after estimating the matching relation, the image analyzer recognizes the building by using the following equation:
$$α {\sum }_{G} N ( G ) + ( 1 - α ) N ( {P}_{s} ) < T 2 ,$$
where N(G) denotes the number of feature points of an input image or comparative image group, while the number of feature points of a pre-stored (sampled) comparative image group is also denoted by N(G) to be used as a reference for building area recognition, N(Pₛ) denotes the total number of matching cases of an ungrouped single feature vector, α denotes a weight for a feature point used for building recognition, where α may be greater than or equal to 0 and less than 1, and T2 denotes a reference value for determining whether recognition is achieved.

8. The apparatus of claim 6, wherein after estimating the matching relation, the image analyzer improves a building recognition rate by using pose change information.

9. The apparatus of claim 8, wherein the image analyzer is configured to functionalize the pose change information and the number of matched feature points, and thereafter recognize the building in such a manner that the less the error of the pose change information and the greater the number of matched feature points, the higher the possibility of recognizing that buildings of an input image and a comparative image are identical.

10. The apparatus of claim 9, wherein the image analyzer improves the building recognition rate in such a manner that a parameter prioritized for building recognition is configured by regulating a weight of the pose change information or matched feature points.

11. A method for recognizing a building area in a portable terminal, the method comprising:
upon extracting feature points to be used for building recognition, classifying feature points with similarities among the extracted feature points into a group; and
recognizing a building after estimating a matching relation by regarding the classified group as a feature point.

12. The method of claim 11, wherein the classifying of the feature points with similarities comprises:
selecting any feature point among the extracted feature points as a reference point;
comparing a distance between the reference point and a neighboring feature point; and
if the compared distance is less than or equal to a threshold, determining that the compared feature point belongs to the feature points with similarities and classifying the feature points with similarities into the group.

13. The method of claim 12, wherein the determining that the compared feature point belongs to the feature points with similarities is performed by using the following equation:
∥P₁−P₂∥<T1,
where P₁ denotes any reference point among extracted feature points, P₂ denotes another feature point existing in a neighboring area, and T1 denotes a threshold for determining similarities between feature points.

14. The method of claim 12, wherein the classifying of the feature points with similarities into the group comprises:
after classifying the feature points into the group, comparing whether a grouping process is performed for all neighboring feature points;
if the grouping process is not performed for all neighboring feature points, determining an average of feature vectors of the group as a new reference point; and
comparing a distance to the neighboring feature point by using the new reference point.

15. The method of claim 14, wherein the average of the feature vectors is determined by using the following equation:
$${P}_{mean} = \frac{1}{N ( G )} {\sum }_{i = G} {P}_{i} ,$$
where Pₘₑₐₙ denotes an average vector of grouped feature vectors, and N(G) denotes the number of feature points included in the group.

16. The method of claim 11, wherein the recognizing of the building by estimating the matching relation further comprises estimating the matching relation by searching for a representative vector by using the following equation:
∥Pₘₑₐₙ₁−Pₘₑₐₙ₂∥<T1,
where Pₘₑₐₙ denotes a representative vector, ∥Pₘₑₐₙ₁−Pₘₑₐₙ₂∥ denotes a distance between representative vectors, and T1 denotes a threshold for determining the matching relation between the representative vectors.

17. The method of claim 16, wherein the recognizing of the building by estimating the matching relation further comprises, after estimating the matching relation, recognizing the building by using the following equation:
$$α {\sum }_{G} N ( G ) + ( 1 - α ) N ( {P}_{s} ) < T 2 ,$$
where N(G) denotes the number of feature points of an input image or comparative image group, while the number of feature points of a pre-stored (sampled) comparative image group is also denoted by N(G) to be used as a reference for building area recognition, N(Pₛ) denotes the total number of matching cases of an ungrouped single feature vector, α denotes a weight for a feature point used for building recognition, where α may be greater than or equal to 0 and less than 1, and T2 denotes a reference value for determining whether recognition is achieved.

18. The method of claim 16, wherein the recognizing of the building by estimating the matching relation further comprises, after estimating the matching relation, improving a building recognition rate by using pose change information.

19. The method of claim 18, wherein the improving of the building recognition rate by using the pose change information further comprises:
functionalizing the pose change information and the number of matched feature points; and
recognizing the building in such a manner that the less the error of the pose change information and the greater the number of matched feature points, the higher the possibility of recognizing that buildings of an input image and a comparative image are identical.

20. The method of claim 19, wherein the improving of the building recognition rate by using the pose change information further comprises configuring a parameter prioritized for building recognition by regulating a weight of the pose change information or matched feature points.
